(19) United States
(12) Patent Application Publication
(10) Pub. No.: US 2026/0289978 A1
(43) Pub. Date: Sep. 24, 2026

(54) AUTOMATIC FEATURE EXTRACTION FOR IMPROVED VALIDATION OF IMAGE DATA

(71) Applicant: BANK OF AMERICA CORPORATION, Charlotte, NC (US)

(72) Inventors: Sreeram Raghavan, Chennai (IN); Suhasini Mullapudi, Chennai (IN)

(73) Assignee: BANK OF AMERICA CORPORATION, Charlotte, NC (US)

(21) Appl. No.: 19/082,617

(22) Filed: Mar. 18, 2025

(51) Int. Cl. G06V 10/776; G06V 10/44; G06V 10/75; G06V 10/82

(52) U.S. Cl. CPC G06V 10/776; G06V 10/454; G06V 10/755; G06V 10/82

(57) ABSTRACT

Embodiments of the invention are directed to systems, methods, and computer program products for expedited processing of image data obtained through optical character recognition (OCR) processing. In some embodiments, the method includes receiving an image file, applying one or more pre-processing steps to the image file to generate a standardized image file; processing the standardized image file using a hierarchical stacked deformable convolutional neural network (HSDCNN) to identify at least one image feature, where the at least one image feature is associated with a correlation score; inputting the at least one image feature and the correlation score into a large language model, where the large language model is trained to output a decision associated with the image file and, based on the decision, executing a validation process associated with the image file.

### TECHNOLOGICAL FIELD

Example embodiments of the present disclosure relate to a system which uses automatic feature extraction for expedited processing and improved validation of image data.

### BACKGROUND

Because conventional systems for processing paper resource instruments require some degree of manual review, there is no way to approve a paper resource instrument in real time at a virtual point of presentment, such as an ATM.

### BRIEF SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for improved validation of image data is presented. The system may include at least one non-transitory storage device and at least one processor coupled to the at least one non-transitory storage device, where the at least one processor is configured to: receive an image file; apply one or more pre-processing steps to the image file to generate a standardized image file; process the standardized image file using a hierarchical stacked deformable convolutional neural network (HSDCNN) to identify at least one image feature, where the at least one image feature is associated with a correlation score; input the at least one image feature and the correlation score into a large language model, where the large language model is trained to output a decision associated with the image file; and based on the decision, execute a validation process associated with the image file.

In some embodiments, the validation process includes determining that the image file is associated with an external data collection system; accessing the external data collection system via an intelligent gateway; accessing a dataset from the external data collection system; and validating the image file.

In some embodiments, the validation process includes determining that the image file is associated with an internal data collection system; accessing a dataset from the internal data collection system; and validating the image file.

In some embodiments, the one or more preprocessing steps include at least one of: resizing, normalization, color space conversion, data augmentation, standardization, cropping, data type conversion, channel handling, and label encoding.

In some embodiments, the HSDCNN comprises a first layer configured to identify a first set of features, the first set of features having a first degree of granularity and a second layer configured to identify a second set of features, the second set of features having a second degree of granularity different from the first degree of granularity.

In some embodiments, the HSDCNN further includes a third layer configured to identify a third set of features, the third set of features having a third degree of granularity different from the first degree of granularity and the second degree of granularity.

In some embodiments, the HSDCNN further includes an aggregation module configured to fuse the first set of features, the second set of features, and the third set of features to identify the at least one image feature.

In some embodiments, the at least one image feature includes a set of spatial information extracted from the image file.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for improved validation of image data, in accordance with an embodiment of the disclosure;

FIG. 2 illustrates an exemplary machine learning (ML) subsystem architecture 200, in accordance with an embodiment of the invention; and

FIG. 3 illustrates a process flow for improved validation of image data, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

Because conventional systems for processing paper resource instruments require some degree of manual review, there is no way to approve a paper resource instrument in real time at a virtual point of presentment, such as an ATM. To solve this problem, the present invention provides a solution which includes an end-to-end hierarchical stacked deformable convolutional neural network (HSDCNN) which, using the dimensionally reduced vector representation of an input to extract essential features required for the validation, trains a domain specific Large Language Model to optimize a basis for accepting or rejecting an instrument in real time and to drive the information collection and validation, which could result in the instrument being processed further or rejected in real time. The invention further includes a feature-aware attention mechanism that not only utilizes features effectively but also dynamically adjusts sampling locations with learnable offsets to establish better spatial relationships within input data and channelizes focus on more relevant spatial locations within the region of interest.

Accordingly, the present invention relates to a method of obtaining an image file associated with a paper resource instrument such as a check, then applying one or more data pre-processing steps to the image file, such as resizing, color space conversion, scaling, data conversion, label encoding, channel handling, cropping, normalization, or data augmentation. The method also includes using an HSDCNN to extract a set of features from the image file, where each feature is associated with a correlation score, as well as using a domain-specific large language model to determine whether the set of features match a predetermined validation score. Based on an output of the domain-specific large language model, the method may include either validating the paper resource instrument or rejecting the paper resource instrument.

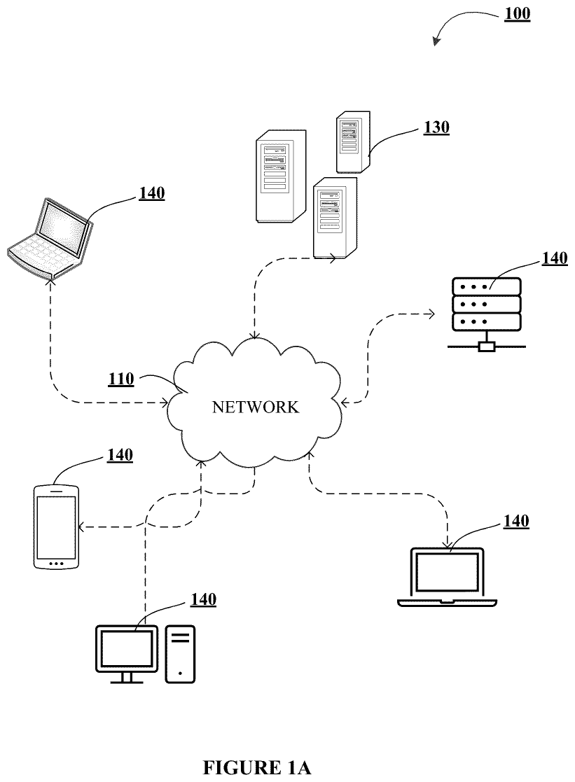

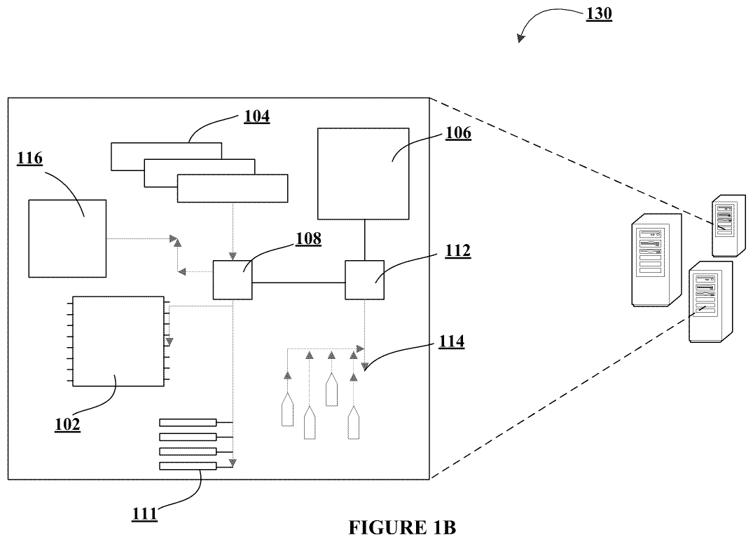

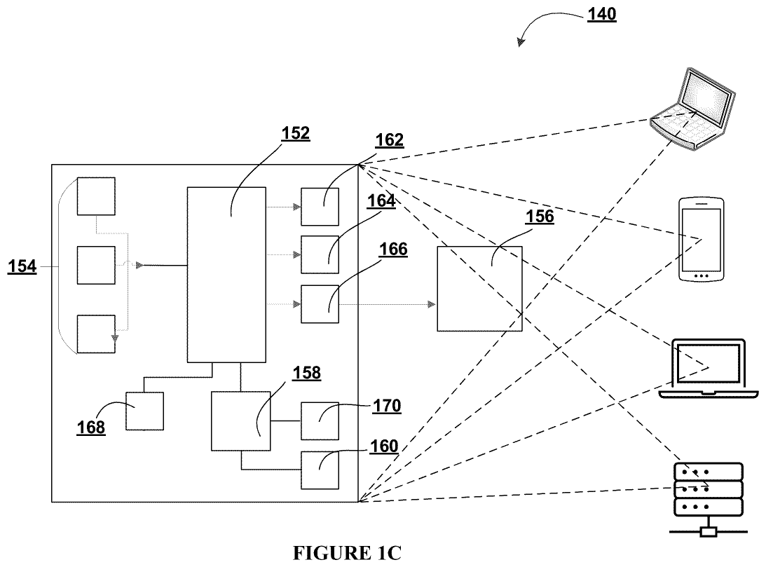

FIGS. 1A-1C illustrate technical components of an exemplary distributed computing environment 100 for the processes described herein, in accordance with an embodiment of the disclosure. As shown in FIG. 1A, the distributed computing environment 100 contemplated herein may include a system 130, an end-point or network device(s) 140, and a network 110 over which the system 130 and end-point or network device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

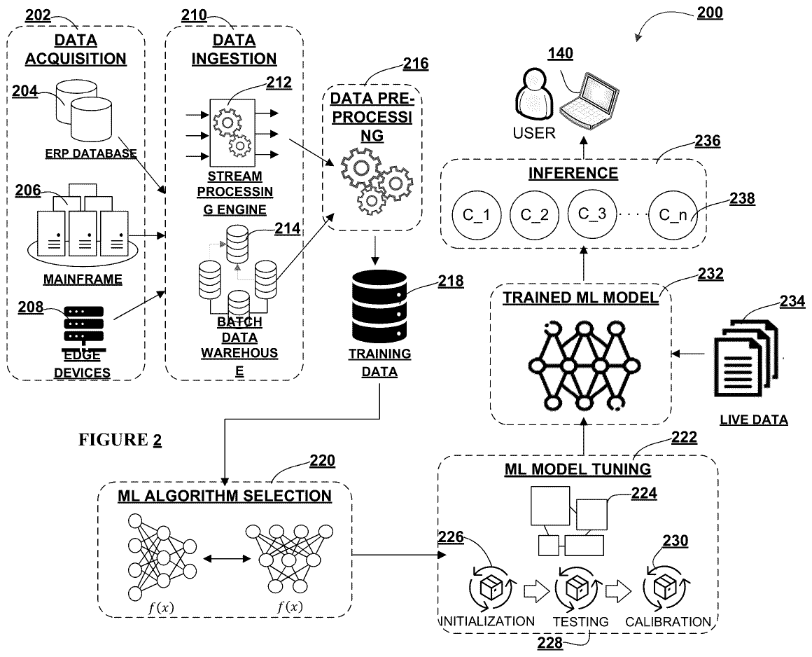

FIG. 2 illustrates an exemplary machine learning (ML) subsystem architecture 200, in accordance with an embodiment of the invention. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include databases that host data related to software architecture (i.e. software component level interactions related to day-to-day business activities such as accounting, procurement, project management, exposure management, supply chain operations, and/or the like), a mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

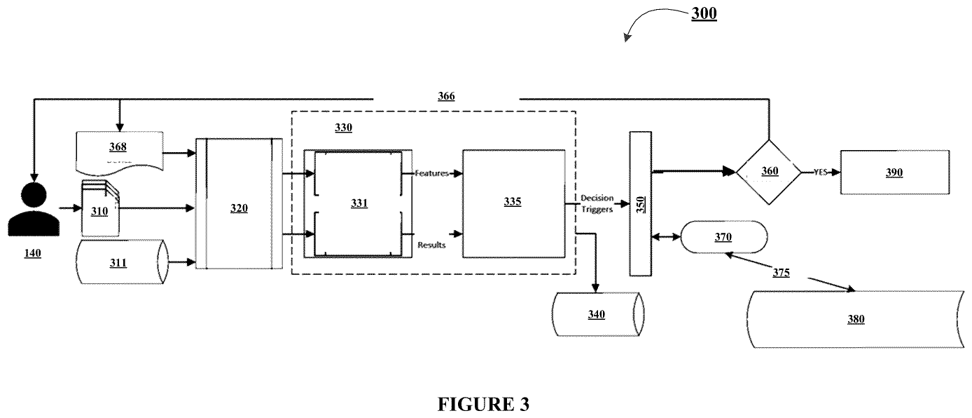

FIG. 3 illustrates a process flow 300 for automatic feature extraction of image data, in accordance with an embodiment of the disclosure. The process flow may begin at block 310, where the system may receive, from a user and/or end-point device 140, an image file. In some embodiments, the image file may be an image of a paper resource instrument such as a check. The system may receive the image file directly (e.g., the user and/or end-point device 140 may upload the image file to the system or to an application programming interface (API) of the system). Additionally or alternatively, the image file may be received through an intermediary device such as an ATM, scanner, and/or the like. For example, the user and/or end-point device may present a paper resource instrument at an ATM, where a scanner of the ATM is configured to generate an image file of the paper resource instrument and transmit the image file to the system.

Additionally or alternatively, the process flow may begin to block 311, where the system is configured to receive the image file from an image file repository. For example, the system may access one or more image files from the image file repository for purposes of training, testing, validating, or otherwise optimizing the outputs of the process flow 300.

The process flow may then continue to block 320, where the system is configured to apply one or more pre-processing steps to the image file received at block 310 and/or block 311. The one or more pre-processing steps may be applied to standardize the image file for further processing (i.e., to account for differences in camera and/or scanner type, lighting conditions, image positioning, and/or the like). By applying the one or more pre-processing steps, the system is configured to minimize the computational complexity of the image file while maintaining the essential spatial characteristics required to image validation. In some embodiments, the one or more pre-processing steps may comprise at least one of resizing, normalization, color space conversion, data augmentation, standardization, cropping and/or padding, data type conversion, channel handling, and label encoding. In a resizing operation, the system may resize the image file to a specific, predetermined dimension. In a normalization operation, the system may normalize pixel values of the image file to a specific range (e.g., [0,1], [−1,1], or the like) to allow for more rapid processing by the machine learning engine as described in greater detail herein. In a color space conversion operation, the system may convert the image file to a predetermined color space, such as RBG, grayscale, HSV, HSL, or the like. In a standardization operation, the system may scale the data of the image file such that each data channel has, for example, a mean of 0 and a standard deviation of 1. In a cropping and/or padding operation, the system may crop the image file in order to remove regions of non-interest or focus only on regions of interest. Furthermore, the system may pad one or more edges of the image in order to maintain a standard aspect ration or to further resize the image file to the specific, predetermined dimension. In a data type conversion operation, the system may convert the image data within the image file to a specific data type optimized for the machine learning engine, such as singe-precision floating-type (float32) format. In a channel handling operation, the system may detect and verify a number of channels within the image file. For example, if the predetermined color space of the image file is RBG, then the system may detect and verify that the image file contains the three data channels required for further processing. In a label encoding operation, the system may covert one or more categorical variables within the image file into a binary format (e.g., by applying a one hot encoding operation) in order to further optimize the image file for processing by the machine learning engine.

When the image file is received from the image repository, the system may apply a data augmentation operation to increase the diversity of the training data supplied to the machine learning engine. For example, the system may apply one or more random transformations to the image file such as random cropping, rotation, horizontal and vertical flipping, random brightness and contract adjustments, and/or random zooming. By applying said random transformations, the system may generate a plurality of training image files from a single base image file, thereby increasing the amount of training data available to the machine learning engine without requiring additional image file inputs.

The process flow may then continue to block 330, where the standardized image file is processed using a machine learning engine configured to output a validation status of the standardization image file. In some embodiments, the machine learning engine comprises multiple processing steps, such as a feature extraction process at block 331 and a validation process 335. The feature extraction process at block 331 may comprise processing the standardized image file via an end-to-end hierarchical stacked deformable convolutional neural network (HSDCNN) to extract a set of features of the image file, where each feature is associated with a correlation score. Specifically, the HSDCNN may consist of multiple deformable convolutional layers, such as one or more lower layers for detecting highly detailed features (e.g., textures, edges, and/or the like), one or more middle layers for detecting less detailed features (e.g., shapes, regions of interest, and/or the like), and one or more upper layers for detecting complex patterns (e.g., text, signatures, objects, and/or the like). Furthermore, the HSDCNN may include a hierarchical aggregation module configured to fuse or combine features identified in the multiple layers and detect global and/or local feature dependencies. By extracting both fine-grained textures from the lower and/or middle layers and high-level representations from the middle and/or upper layers, then fusing the extracted data, the HSDCNN may output a set of extracted features, where each extracted feature includes a set of spatial information associated with the extracted feature and correlation score associated with a degree of confidence in the HSDCNN output.

The process flow may then continue to block 335, where the set of extracted features and the associated results (i.e., correlation scores) are input into a domain specific large language model (LLM), where the LLM is configured to optimize a basis for validating or failing to validate the image file. For example, in some embodiments, the LLM comprises a bidirectional autoregressive module (i.e., a computer vision transformer) configured to interpret the inputted data and output one or more decision triggers. The one or more decision triggers may include, for example, validating the image file according to a predetermined set of validation criteria, failing to validate the image file according to the predetermined set of validation criteria, dynamically updating the set of validation criteria, and/or identifying additional data required to validate the image file.

The process flow may then continue to block 350, where, based on the decision triggers, the system may proceed to an additional information collection step. For example, if the decision triggers indicate that additional data is required to validate the image file, the system may then determine whether the image file is associated with an internal data collection system or an external data collection system. In some embodiments, the system may make said determination based on additional information associated with the user and/or end-point device of block 310. For example, the system may determine that the user of block 310 is associated with account information stored in an internal data collection system. In this example, the system may then query the internal data collection system for the additional data required to validate the image file. Additionally or alternatively, the system may determine that the user and/or end-point device of block 310 is associated with an external data collection system 380, and may then proceed to block 370, whereby the system uses an intelligent gateway 375 to communicate with the external data collection system 380 and access the required information.

The process flow may then continue to block 360, where the system makes a final determination on the validation status of the image file based on the decision triggers and/or the additional information collected at block 350. In some embodiments, the system may validate the image file and may then continue to block 390, where the image file is transmitted to another computing device and/or system for further processing. At block 390, the system may be further configured to transmit a notification to the user and/or end point device 140 indicating that the image file was successfully validated. Additionally or alternatively, the validated image file may be stored in the image file repository 311 for future training of the machine learning engine.

If the image file is not validated at block 360, the system may then proceed to block 366, where the system is configured to notify the user and/or end-point device that the image file was not successfully validated. In some embodiments, the notification may further prompt the user and/or end-point device to upload or transmit a second image file 386, and the process flow may repeat using the second image file 386.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for improved validation of image data, the system comprising:
at least one non-transitory storage device; and
at least one processor coupled to the at least one non-transitory storage device, wherein the at least one processor is configured to:
receive an image file;
apply one or more pre-processing steps to the image file to generate a standardized image file;
process the standardized image file using a hierarchical stacked deformable convolutional neural network (HSDCNN) to identify at least one image feature, wherein the at least one image feature is associated with a correlation score;
input the at least one image feature and the correlation score into a large language model, wherein the large language model is trained to output a decision associated with the image file; and
based on the decision, execute a validation process associated with the image file.

2. The system of claim 1, wherein the validation process comprises:
determining that the image file is associated with an external data collection system;
accessing the external data collection system via an intelligent gateway;
accessing a dataset from the external data collection system; and
validating the image file.

3. The system of claim 1, wherein the validation process comprises:
determining that the image file is associated with an internal data collection system;
accessing a dataset from the internal data collection system; and
validating the image file.

4. The system of claim 1, wherein the one or more preprocessing steps include at least one of: resizing, normalization, color space conversion, data augmentation, standardization, cropping, data type conversion, channel handling, and label encoding.

5. The system of claim 1, wherein the HSDCNN comprises a first layer configured to identify a first set of features, the first set of features having a first degree of granularity and a second layer configured to identify a second set of features, the second set of features having a second degree of granularity different from the first degree of granularity.

6. The system of claim 5, wherein the HSDCNN further comprises a third layer configured to identify a third set of features, the third set of features having a third degree of granularity different from the first degree of granularity and the second degree of granularity.

7. The system of claim 6, wherein the HSDCNN further comprises an aggregation module configured to fuse the first set of features, the second set of features, and the third set of features to identify the at least one image feature.

8. The system of claim 1, wherein the at least one image feature comprises a set of spatial information extracted from the image file.

9. A computer program product for improved validation of image data, the computer program product comprising a non-transitory computer-readable medium comprising code causing an apparatus to:
receive an image file;
apply one or more pre-processing steps to the image file to generate a standardized image file;
process the standardized image file using a hierarchical stacked deformable convolutional neural network (HSDCNN) to identify at least one image feature, wherein the at least one image feature is associated with a correlation score;
input the at least one image feature and the correlation score into a large language model, wherein the large language model is trained to output a decision associated with the image file; and
based on the decision, execute a validation process associated with the image file.

10. The computer program product of claim 9, wherein the validation process comprises:
determining that the image file is associated with an external data collection system;
accessing the external data collection system via an intelligent gateway;
accessing a dataset from the external data collection system; and
validating the image file.

11. The computer program product of claim 9, wherein the validation process comprises:
determining that the image file is associated with an internal data collection system;
accessing a dataset from the internal data collection system; and
validating the image file.

12. The computer program product of claim 11, wherein the one or more preprocessing steps include at least one of: resizing, normalization, color space conversion, data augmentation, standardization, cropping, data type conversion, channel handling, and label encoding.

13. The computer program product of claim 11, wherein the HSDCNN comprises a first layer configured to identify a first set of features, the first set of features having a first degree of granularity and a second layer configured to identify a second set of features, the second set of features having a second degree of granularity different from the first degree of granularity.

14. The computer program product of claim 13, wherein the HSDCNN further comprises a third layer configured to identify a third set of features, the third set of features having a third degree of granularity different from the first degree of granularity and the second degree of granularity.

15. The computer program product of claim 14, wherein the HSDCNN further comprises an aggregation module configured to fuse the first set of features, the second set of features, and the third set of features to identify the at least one image feature.

16. The computer program product of claim 9, wherein the at least one image feature comprises a set of spatial information extracted from the image file.

17. A method for improved validation of image data, the method comprising:
receiving an image file;
applying one or more pre-processing steps to the image file to generate a standardized image file;
processing the standardized image file using a hierarchical stacked deformable convolutional neural network (HSDCNN) to identify at least one image feature, wherein the at least one image feature is associated with a correlation score;
inputting the at least one image feature and the correlation score into a large language model, wherein the large language model is trained to output a decision associated with the image file; and
based on the decision, executing a validation process associated with the image file.

18. The method of claim 17, wherein the validation process comprises:
determining that the image file is associated with an external data collection system;
accessing the external data collection system via an intelligent gateway;
accessing a dataset from the external data collection system; and
validating the image file.

19. The method of claim 17, wherein the one or more preprocessing steps include at least one of: resizing, normalization, color space conversion, data augmentation, standardization, cropping, data type conversion, channel handling, and label encoding.

20. The method of claim 17, wherein the HSDCNN comprises:
a first layer configured to identify a first set of features, the first set of features having a first degree of granularity;
a second layer configured to identify a second set of features, the second set of features having a second degree of granularity different from the first degree of granularity; and
a third layer configured to identify a third set of features, the third set of features having a third degree of granularity different from the first degree of granularity and the second degree of granularity.
